(19) United States
(12) Patent Application Publication
(10) Pub. No.: US 2016/0203490 A1
(43) Pub. Date: Jul. 14, 2016

(54) Systems and Methods for Travel-Related Anomaly Detection

(71) Applicant: SAS Institute Inc., Cary, NC (US)

(72) Inventors: Ankur Gupta, San Diego, CA (US); Brian Lee Duke, Poway, CA (US); Binbin Li, San Diego, CA (US); Prathaban Mookiah, San Diego, CA (US)

(21) Appl. No.: 15/009,475

(22) Filed: Jan. 28, 2016

Related U.S. Application Data
(63) Continuation-in-part of application No. 14/557,009, filed on Dec. 1, 2014.
(60) Provisional application No. 62/108,670, filed on Jan. 28, 2015.

(30) Foreign Application Priority Data
Dec. 10, 2013 (IN) 3585/DEL/2013

(51) Int. Cl. G06Q 20/40; G06Q 20/38

(52) U.S. Cl. CPC G06Q 20/4016; G06Q 20/382

(57) ABSTRACT

A fraud score for a transaction in connection with an account is computed from retrieved data to indicate a probability of the account being in a compromised condition. A travel score is computed, wherein the computed travel score indicates a likelihood that a user of the account is traveling from a user home location at the time of the received transaction. A self-similarity score may be computed if the computed fraud score is above a predetermined threshold to indicate similarity of the received transaction to other transactions of the account in the set of prior transactions. A suggested action is determined, based on a fraud decisioning operation (and optionally the self-similarity score) and a travel decisioning operation using the fraud score and travel score, respectively.

### CROSS-REFERENCE TO RELATED APPLICATIONS

The present disclosure claims the benefit of priority to U.S. Provisional Application No. 62/108,670 filed Jan. 28, 2015, the entirety of which is incorporated herein by reference.

### SUMMARY

The disclosure provides a computer system that includes a network device having a processor and a non-transitory computer-readable storage medium that includes instructions that are configured to be executed by the processor. When the network device processor executes the instructions, the computer system performs operations including retrieving data from data storage of the system and computing a fraud score in connection with an account to which the received transaction relates. The transaction received at the system relates to the account, and the data storage includes data relating to a plurality of accounts, each of which is associated with an account owner, and the collection of accounts comprises an account population. The computed fraud score indicates a probability of the account being in a compromised condition. In response to executing the instructions for the operations of retrieving data and computing a fraud score, the computer system also computes a travel score in connection with the account to which the received transaction relates, wherein the computed travel score indicates a likelihood that a user of the account is traveling from a user home location at the time of the received transaction and is computed using data received over a network configured to communicate with the computer system. The system also perform one or both of a fraud decisioning operation and a travel decisioning operation in response to the computed fraud score and computed travel score, and determines a suggested action based on the fraud decisioning operation and the travel decisioning operation.

The disclosure further provides a system wherein performing the fraud decisioning operation comprises computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions.

The disclosure further provides a system wherein performing the travel decisioning operation comprises updating user profile data of the account user determined to be traveling.

The disclosure further provides a computer-program product, wherein the determined suggested action comprises initiating a marketing process in response to a computed travel score that is above a predetermined travel threshold.

The disclosure further provides a system wherein the determined suggested action comprises reducing a fraud risk ranking for the received transaction, in response to a computed fraud score that is above a predetermined fraud threshold and a computed travel score that is above a predetermined travel threshold.

The disclosure further provides a system wherein the determined suggested action comprises reducing a fraud risk ranking for the received transaction in response to a computed fraud score that is below a predetermined fraud threshold and a computed travel score that is above a predetermined travel score threshold.

The disclosure further provides a system wherein the determined suggested action comprises increasing a fraud risk ranking for the received transaction in response to a computed fraud score that is above a predetermined fraud threshold and a computed travel score that is below a predetermined travel score threshold.

The disclosure further provides a system wherein the determined suggested action comprises updating user profile data of the account user in response to a computed fraud score that is below a predetermined fraud threshold and a computed travel score that is below a predetermined travel score threshold.

The disclosure further provides a system wherein the performed operations further comprise providing the suggested action to a transaction processing system.

The disclosure further provides a system further comprising instructions for providing the suggested action to a transaction processing system.

The disclosure further provides a computer program product, tangibly embodied in a non-transitory machine-readable storage medium for a data processing apparatus of a computer system, such that the computer program product includes instructions configured to be executed to cause the data processing apparatus, comprising a network device and having a processor, to perform a method that includes retrieving data from data storage of the system in connection with a transaction received at the system relating to an account, wherein the data storage includes data relating to a plurality of accounts, each of which is associated with an account owner, and wherein the collection of accounts comprises an account population. The performed method includes computing a fraud score in connection with the account to which the received transaction relates, wherein the computed fraud score indicates a probability of the account being in a compromised condition, and computing a travel score in connection with the account to which the received transaction relates, wherein the computed travel score indicates a likelihood that a user of the account is traveling from a user home location at the time of the received transaction and is computed using data received over a network configured to communicate with the computer system. The performed method further includes performing one or both of a fraud decisioning operation and a travel decisioning operation in response to the computed fraud score and computed travel score and determining a suggested action based on the fraud decisioning operation and the travel decisioning operation.

The disclosure further provides a method of operating a computer system such that the method comprises retrieving data, at a network device of the computer system, from data storage of the system in connection with a transaction received at the system relating to an account, wherein the data storage includes data relating to a plurality of accounts, each of which is associated with an account owner, and wherein the collection of accounts comprises an account population. The method further includes computing a fraud score in connection with the account to which the received transaction relates, wherein the computed fraud score indicates a probability of the account being in a compromised condition, and computing a travel score in connection with the account to which the received transaction relates, wherein the computed travel score indicates a likelihood that a user of the account is traveling from a user home location at the time of the received transaction and is computed using data received over a network configured to communicate with the computer system. The method also includes performing one or both of a fraud decisioning operation and a travel decisioning operation in response to the computed fraud score and computed travel score, and determining a suggested action based on the fraud decisioning operation and the travel decisioning operation.

In accordance with the teachings provided herein, systems and methods for automated generation of transaction scores related to transactions involving a customer account are provided. The customer account is typically associated with a transaction card or other means of initiating a credit or debit transaction. The customer account will be referred to as “the card” for convenience of discussion. The transaction scores measure the likelihood that the card is currently compromised. This continues to be an aspect of fraud detection. However, for the purpose of talking to customers and explaining actions to them, another aspect is to have a second score that describes how similar a given transaction is to the customer/card/account's previous transaction history. This measurement has conventionally remained inseparable from other aspects in assessment of risk with respect to the fraud detection score. The technique disclosed herein makes these two transaction score factors separate, so that an entity can use multiple factors to control risk and customer experience. The transaction score measurement can be made independent of the assessment of whether the card is currently compromised.

In accordance with the disclosure, a fraud score for a transaction in connection with an account is computed from retrieved data to indicate a probability of the account being in a compromised condition. A travel score, in connection with the account to which the received transaction relates, is computed, wherein the computed travel score indicates a likelihood that a user of the account is traveling from a user home location at the time of the received transaction. A self-similarity score may be computed if the computed fraud score is above a predetermined threshold to indicate similarity of the received transaction to other transactions of the account in the set of prior transactions. A suggested action is determined, based on the computed fraud score and the computed travel score.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates an example of a portion of a communications grid computing system including a control node and a worker node, according to some embodiments of the present technology.

FIG. 7 illustrates an example of a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to embodiments of the present technology.

FIG. 11 illustrates an example of a flow diagram for generating scores related to transactions involving a customer account.

FIG. 12 illustrates another example of a flow diagram for generating scores related to transactions involving a customer account.

FIG. 13 illustrates an example of a graphical user interface display that depicts transaction data of an individual with transaction amount along the x-axis and transaction velocity along the y-axis.

FIG. 14 illustrates an example of a graphical user interface display for generating scores related to transactions involving a customer account.

FIG. 15 illustrates an example of a flow diagram for generating fraud scores and travel scores related to transactions involving a customer account.

Like reference numbers and designations in the various drawings indicate like elements.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

The disclosed system produces a fraud score for a transaction in connection with an account such that the fraud score is computed from retrieved data to indicate a probability of the account being in a compromised condition. A travel score is computed, wherein the computed travel score indicates a likelihood that a user of the account is traveling from a user home location at the time of the received transaction. A self-similarity score may be computed if the computed fraud score is above a predetermined threshold to indicate similarity of the received transaction to other transactions of the account in the set of prior transactions. A suggested action is determined, based on the computed fraud score (and optionally the self-similarity score) and the computed travel score.

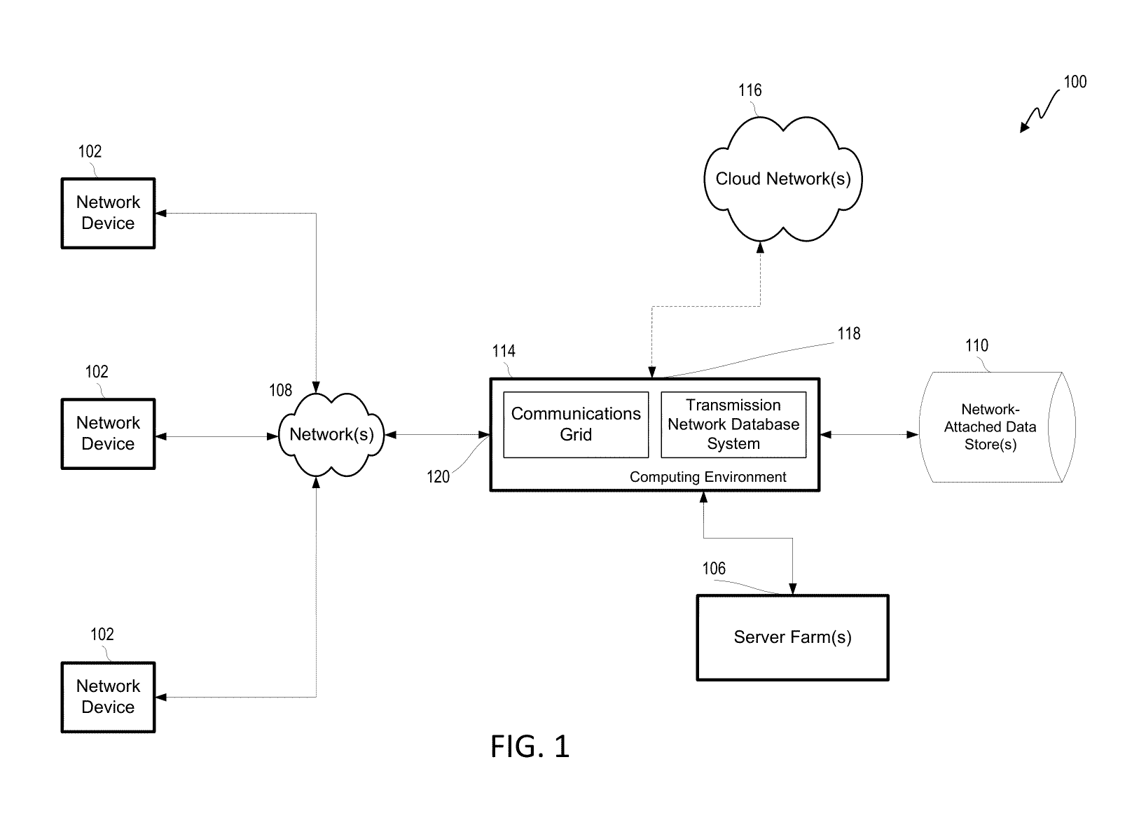

FIG. 1 is a block diagram that provides an illustration of the hardware components of a data transmission network 100, according to embodiments of the present technology. The data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

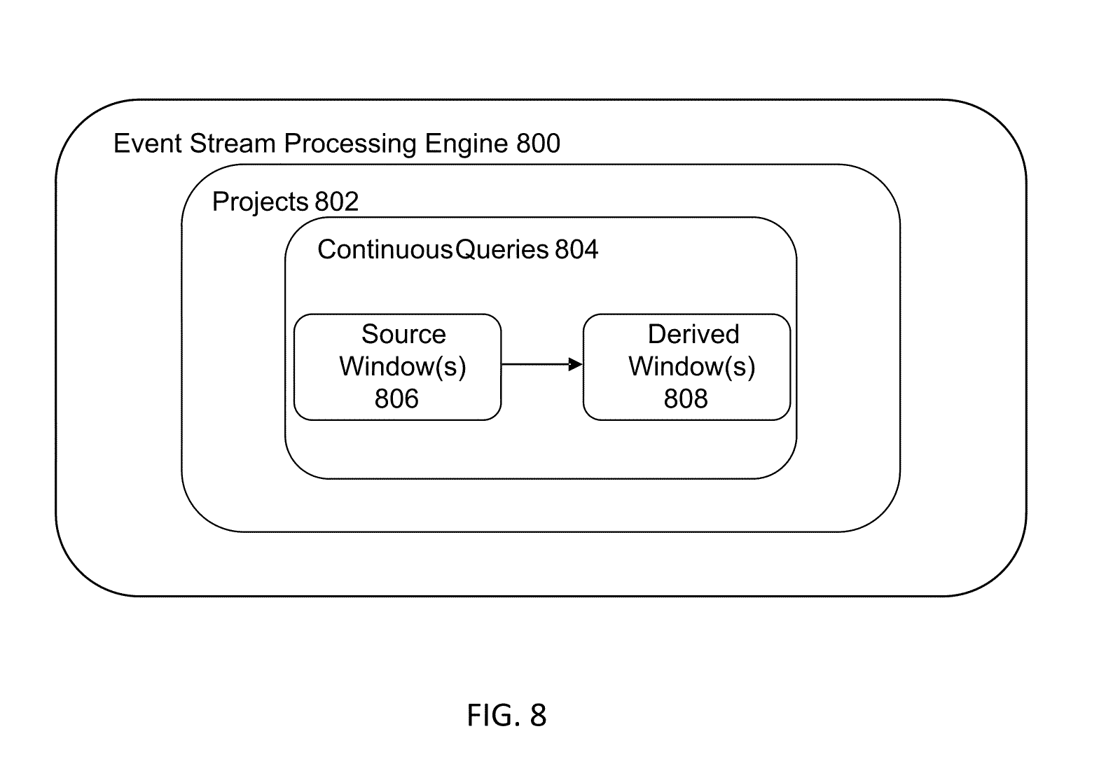

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP or MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

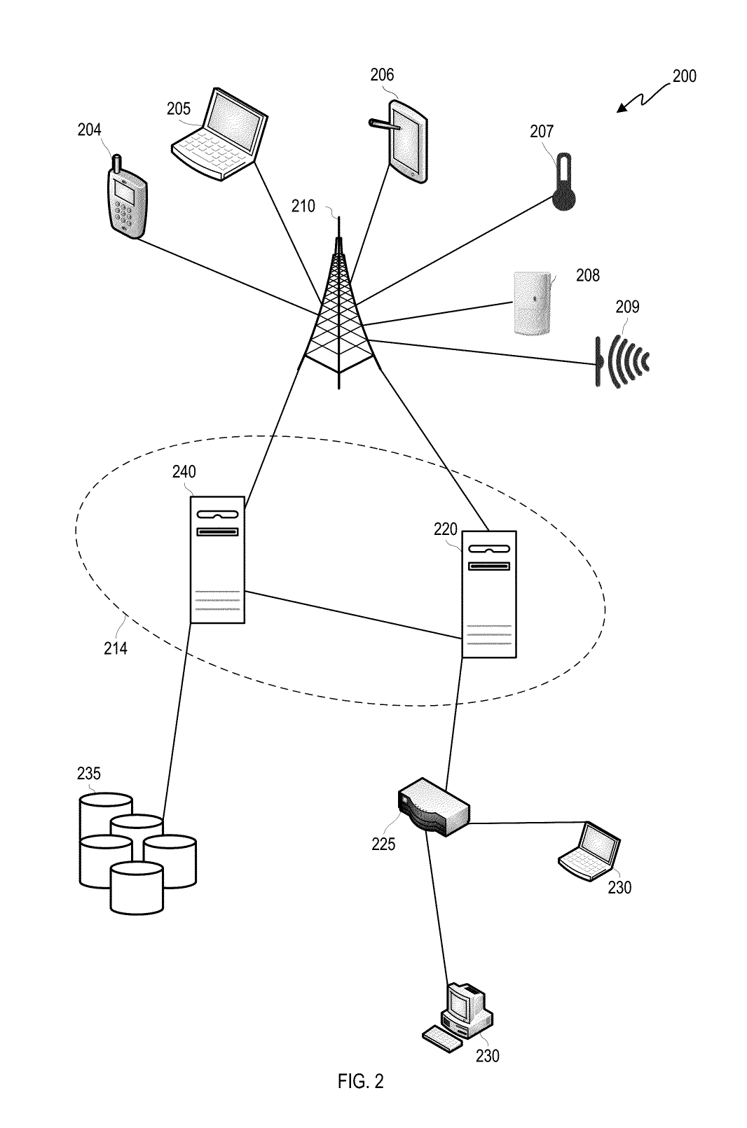

Each communication within data transmission network 100 (e.g., between client devices, between a device and connection management system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 240, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

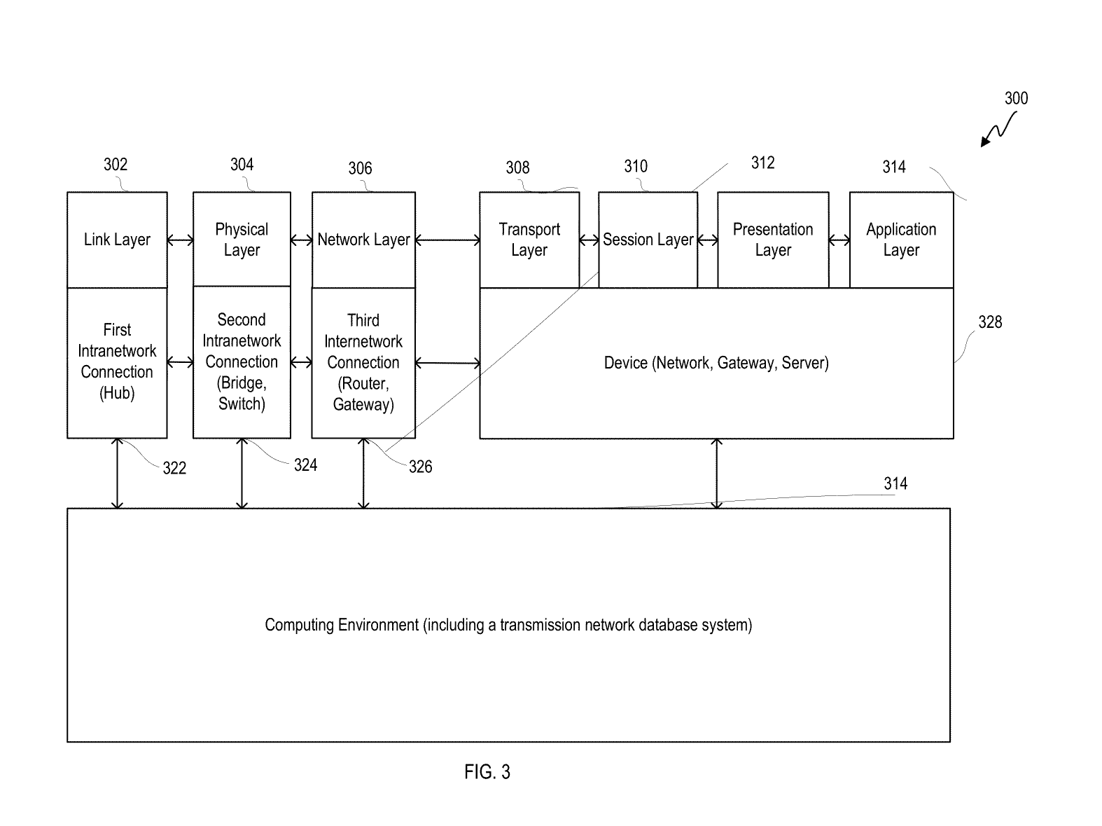

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-314. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer manages node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can manage the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 314 interacts directly with software applications and end users, and manages communications between them. Application layer 314 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-314. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

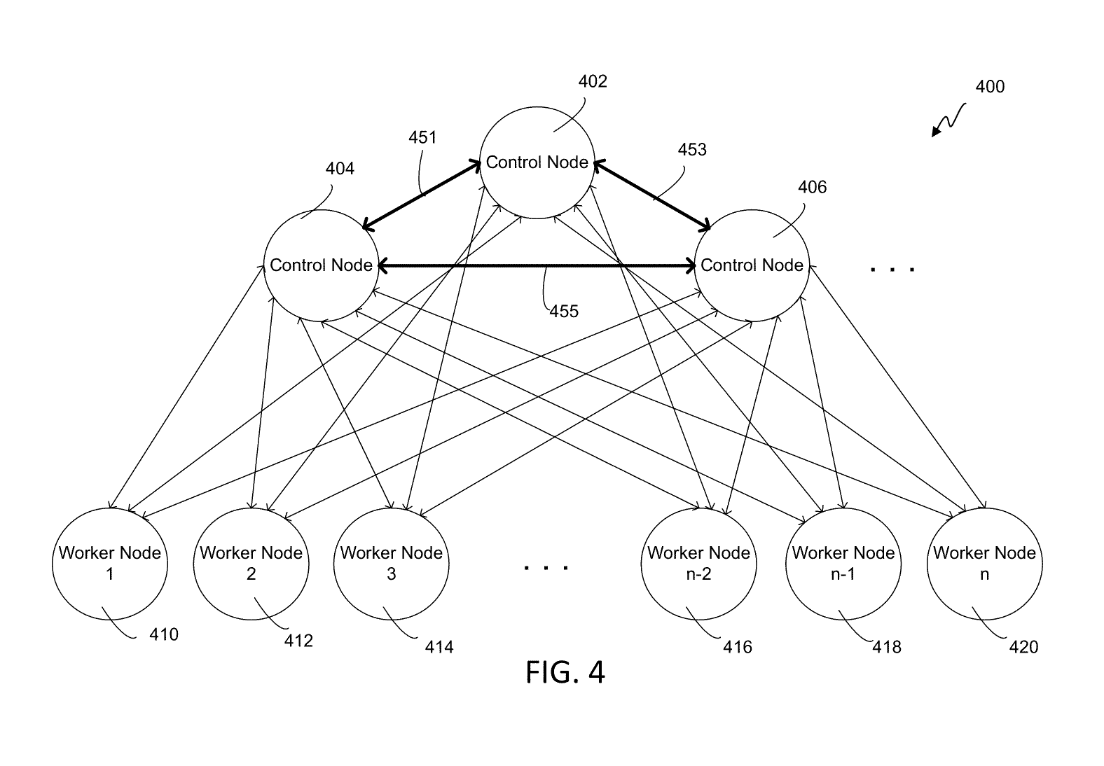

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

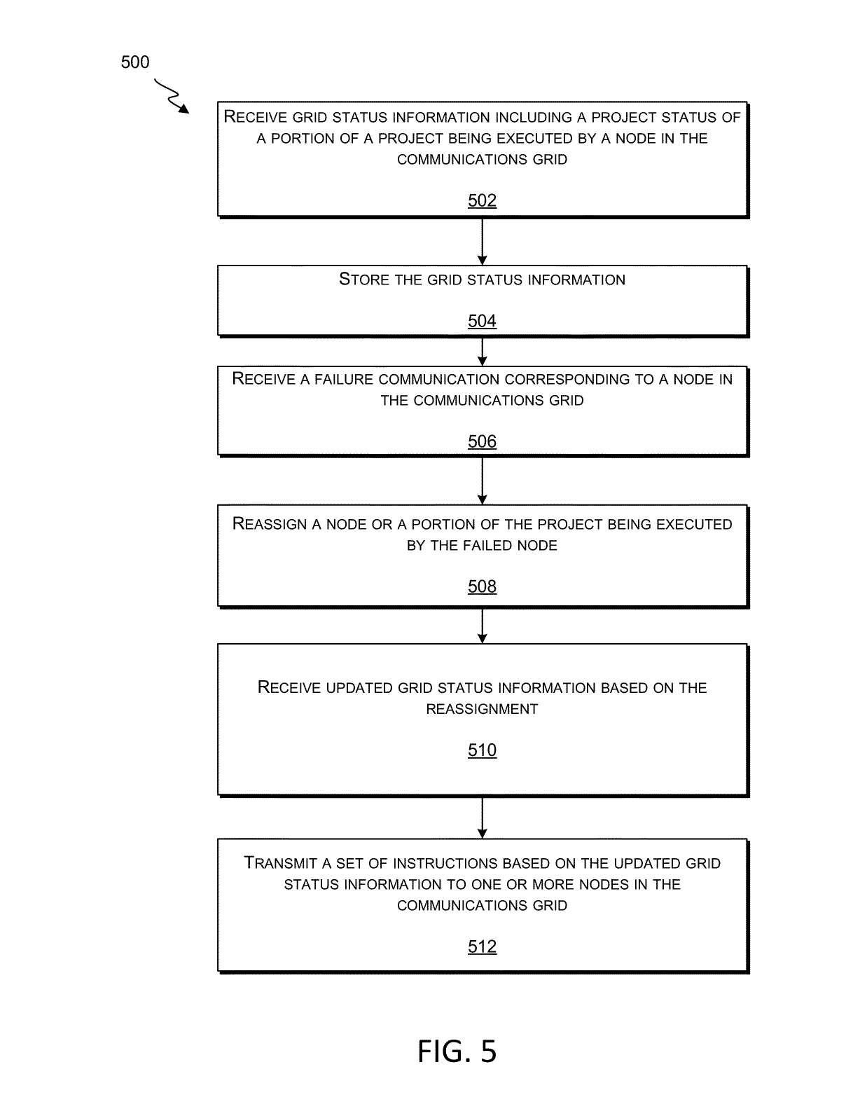

FIG. 5 illustrates a flow chart showing an example process for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

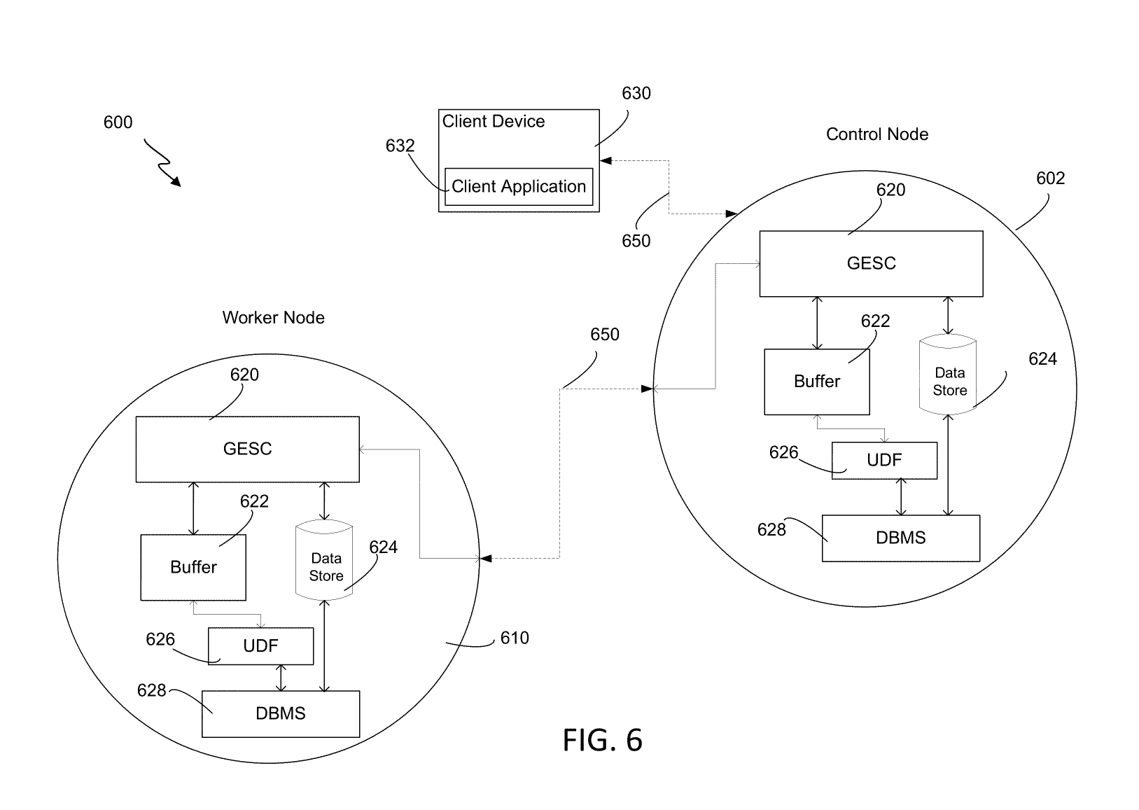

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

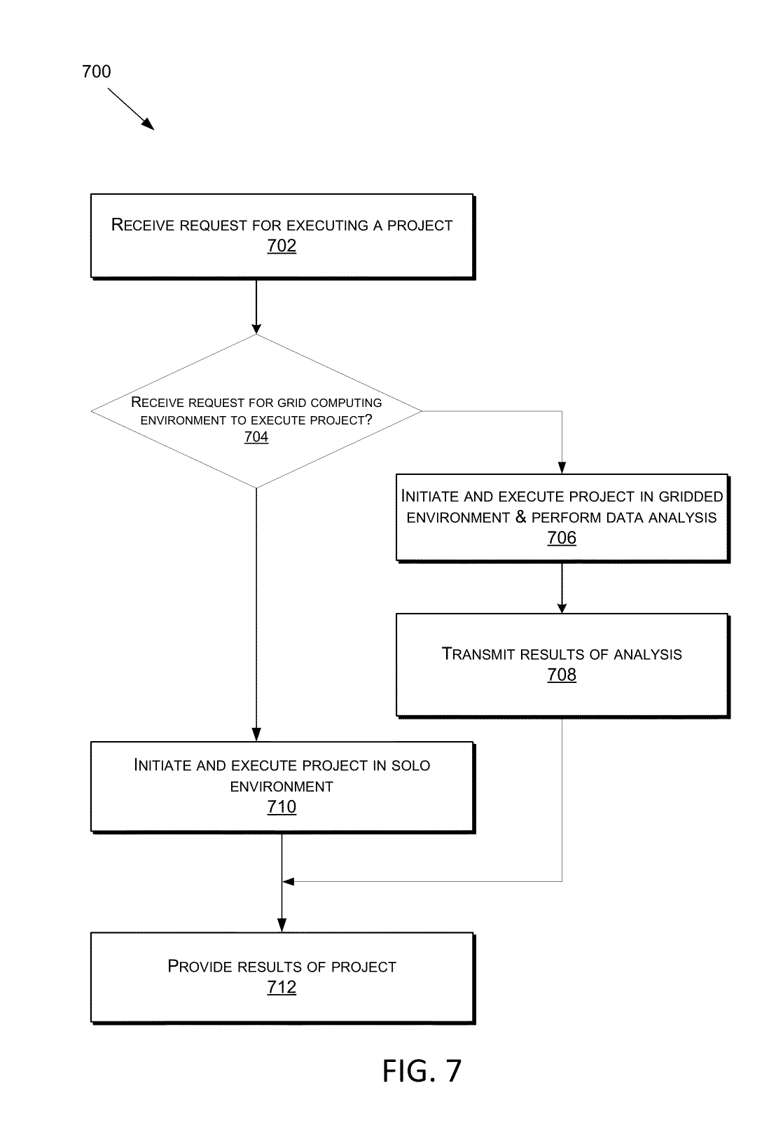

FIG. 7 illustrates a flow chart showing an example method for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

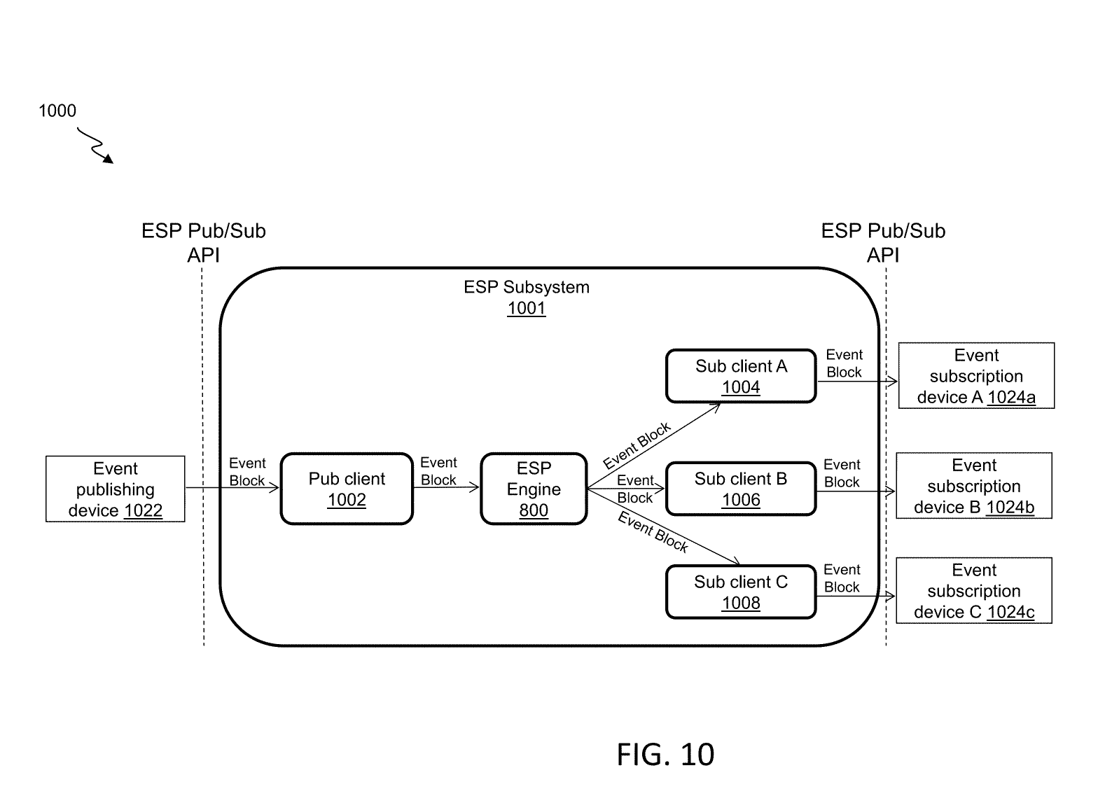

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

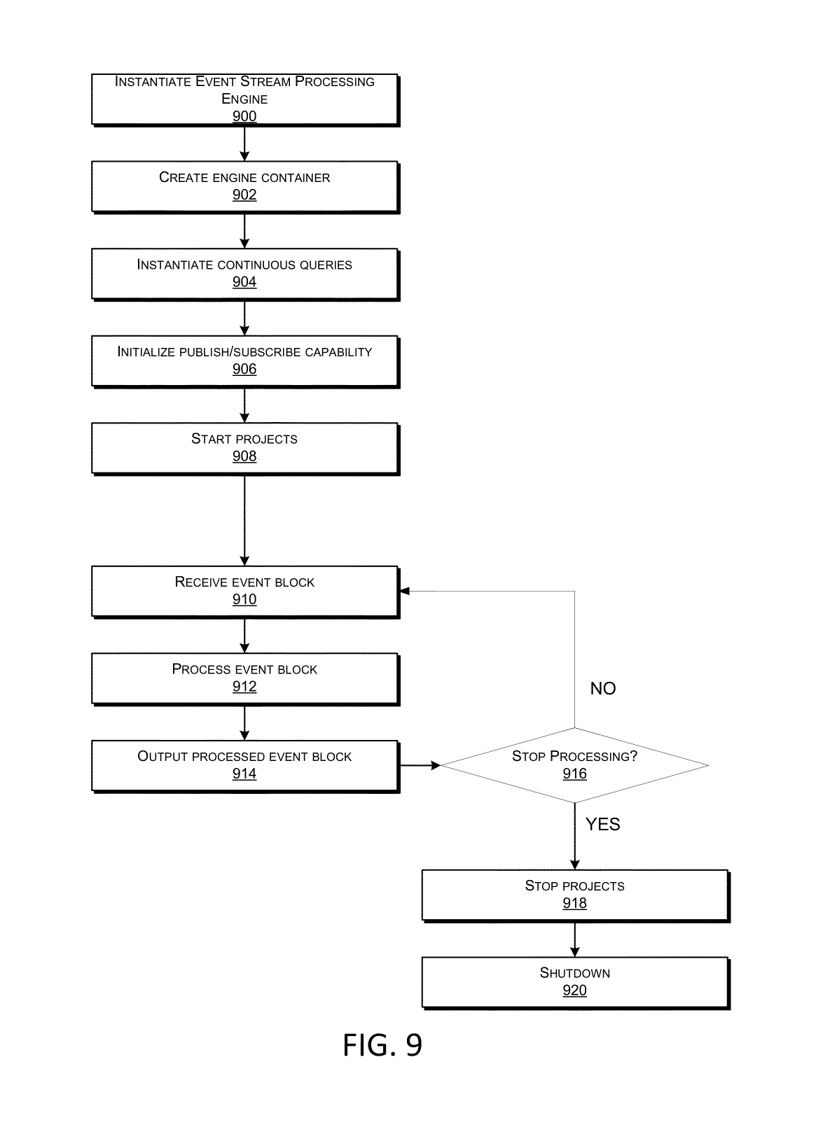

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

The present disclosure is a continuation-in-part application of U.S. patent application Ser. No. 14/557,009 filed Dec. 1, 2014, the entirety of which is incorporated herein by reference, which claims the benefit of priority under 35 U.S.C. §119(e) to U.S. Provisional Application No. 62/002,172 filed May 22, 2014, the entirety of which is incorporated herein by reference, which claims the benefit of priority to India Application No. 3585/DEL/2013 filed Dec. 10, 2013, the entirety of which is incorporated herein by reference.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

Also disclosed are methods that, in real time, allows for a score to be created that measures the similarity or lack of similarity between a given activity (e.g., a purchase using a credit or debit card) and a set of historical activities for a given card, account, or customer.

Aspects of this particular method can be more individualized in nature. For example, the method can associate a particular activity with a card, account, or customer's previous activity.

Frequently in fraud detection, entities may want to know how similar a given purchase transaction is to a customer's or card's previous purchase history. When a card is compromised by a fraudster, there may be a counterfeit copy of the card being used by the fraudster at the same time a legitimate copy of the card is being used by the legitimate cardholder. The problem is that the entity may wish to decline the transactions that are unusual for the cardholder while approving transactions that are typical for the legitimate cardholder. For example, if a customer goes to the same coffee shop every morning on the way to work, even if his or her card has been compromised and is currently being used by a fraudster, the transactions at the coffee shop should be approved because the entity can be fairly certain that it is the customer, given the customer's long history of visiting this same merchant at similar times of day and amounts to engage in a similar transaction. Rather than decline or approve the transaction, the entity may instead call the customer and ask about any recent suspicious activity. In this situation, the transaction at the coffee shop should not be considered suspicious.

When the card is compromised by a fraudster, there may be a counterfeit copy of the card being used by the fraudster at the same time a legitimate copy of the card is being used by the legitimate cardholder. The problem is that the entity may wish to decline the transactions that are unusual for the cardholder while approving transactions that are clearly made by the legitimate cardholder.

Entities have found that a customer is often irritated when the customer is declined for a transaction and does not understand the reasoning behind the decline. In the above example, if the customer was declined at the coffee shop, the customer would be angry because the customer shops there every day and is accustomed to having no difficulty with the charge. However, if the customer makes an unusual purchase that is something outside of normal spending patterns, then the entity would have an easier time explaining to the customer the reason for being declined.

As noted above, entities have found that customers may become annoyed and irritated when their transactions are declined and they do not understand the reasoning behind those declined transactions. For example, if the customer's attempt to make a purchase at a coffee shop was declined by the entity, then the customer may be angry if the customer shops there every day. However, if the customer made an unusual purchase that is something outside of the customer's normal spending pattern, with the availability of a self-similarity measure in the entity, it would have an easier time explaining to the customer why the transaction was declined.

Some algorithms create scores that measure the likelihood that the card is currently compromised. This can be an aspect of fraud detection. However, another aspect can be to have a second score that describes how similar a given transaction is to the customer/card/account's previous transaction history. This is also useful for the purpose of talking to customers and explaining actions to them. While this self-similarity measurement may be already a part of the conventional fraud detection score, it has remained inseparable from other aspects in assessment of risk. The disclosed method makes at least these two factors separate so that an entity can use multiple factors to control risk and customer experience. This measurement can be made independently of the assessment of whether the card is currently compromised. In order to do this, technology such as decision trees, PCA (principal component analysis), and CNN (compression neural networks), for example, may be used to create a measure of how similar or dissimilar a given transaction is from a group of previous transactions. Training such a model can be performed with or without a target, depending on the needs and desires of the end client. The techniques for creating scores for measuring likelihood of a card being compromised and for describing transaction similarity may be implemented using a variety of devices. Such devices would be specially configured to perform the operations described herein. The devices may include, for example, the network devices described above. As noted, network devices may include network computers, sensors, databases, or other devices that may transmit or otherwise provide data to a computing environment. For example, network devices may include local area network devices, such as routers, hubs, switches, or other computer networking devices, and network devices may also include sensors that monitor their environment or other devices to collect data regarding that environment or those devices, and such network devices may provide data they collect over time. Network devices may also include devices within the internet of things, such as devices within a home automation network. As noted above, some of these devices may be referred to as edge devices. Details of the techniques used to compute the scores from the variables will likely comprise typical machine learning methods, such as neural networks, logistic regression, and the like, as known by those skilled in the art. Such techniques will usually be dependent on design preferences, entity protocols and data design, system resources, and the like.

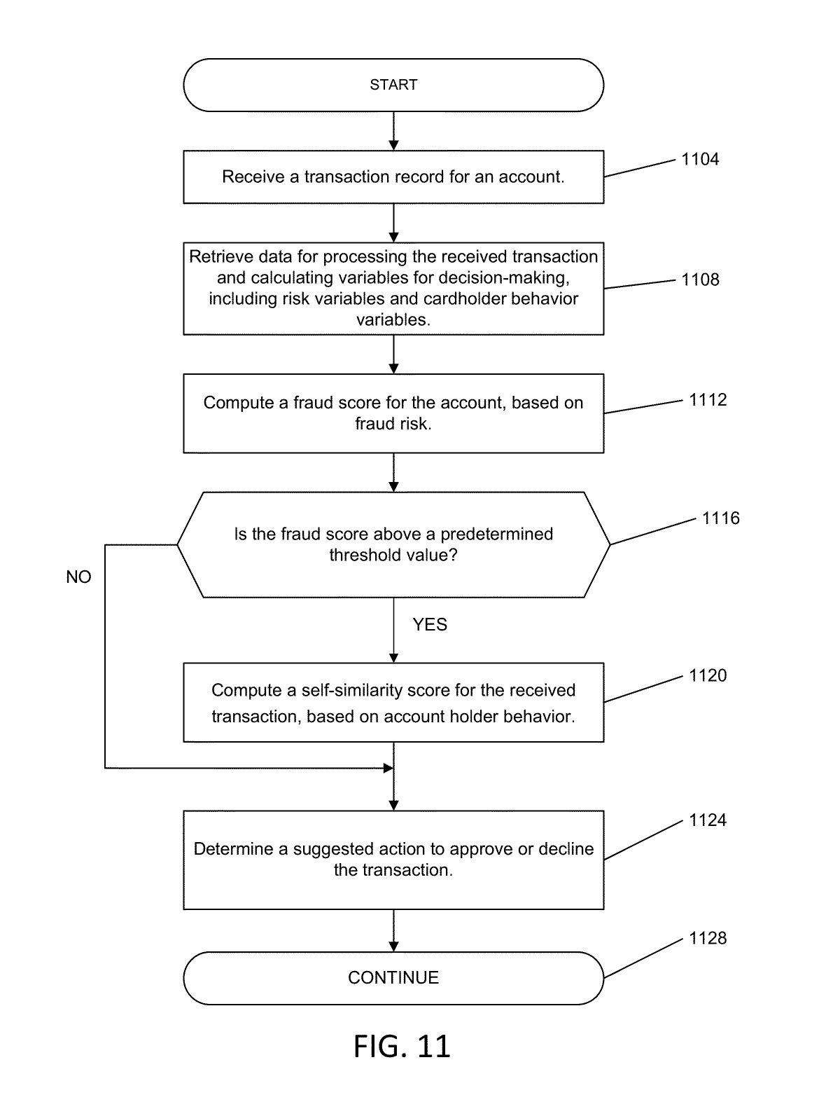

FIG. 11 illustrates an example of a flow diagram for generating transaction scores related to transactions involving a customer account, in which a transaction such as a purchase is presented by a processing system to the computer-implemented environment 100 for an authorization suggestion. In the first operation, illustrated by the box numbered 1104, the computer-implemented environment 100 receives a transaction record for an account. The transaction record may comprise, for example, data relating to a purchase transaction for which authorization to charge an account of a customer is requested. The account typically relates to a credit or debit card, or electronic equivalent, for which the customer is obligated to make payment. A customer may have multiple accounts, but each transaction will relate to only one single account, and the customer behavior data discussed below relates to only the account associated with the transaction.

At the next operation, at the box 1108 of FIG. 11, the system retrieves data for processing the received transaction and calculates variables for decision-making, including risk variables and cardholder behavior variables. The retrieved data typically includes customer identification data and purchase location data, based on the card account number and the merchant information that typically accompanies the request for authorization of the transaction. The retrieved data also includes risk variables such as risk values associated with the transaction location, transaction amount, time of day, goods or services, and the like. The retrieved data is selected according to decisions of the processing system administrators during configuration of the system. The selection of data to be retrieved includes decisions by the system administrators as to the risk variables that have been deemed important to authorization decision making. That is, the data to be retrieved by the system will be selected by authorized persons during system configuration, in accordance with the user needs for the environment in which the system is being implemented, because the data will be the set of data deemed useful by system administrators in authorization decision making, which data sets will be different for different systems, users, and environments.

The retrieved data also possibly includes cardholder (i.e., account owner) behavior variables, which will typically be in the form of statistical variables, such as typical transaction location, average transaction amount, typical transaction time of day, average amount of goods or services charged, and the like. For example, the “typical transaction location” risk variables may comprise an indicator that compares typical postal codes or addresses or geographic information and determines if the present transaction location corresponds to a postal code or address or other geographic information that indicates a location that is unusually risky from the locations that the user normally frequents. In such an example, an “unusually risky” location is a location at which a determined location risk value (e.g., for loss or fraud) is greater than a threshold risk value set by the system implementation. The location-based risk variables as part of a risk determination for a user may include many such “typical transaction locations”, such as locations near the user's residence, near a school, near a work location, and the like, for example. Some other examples could comprise comparison of typical merchants, merchant category code, transaction amount bins, or times of day the user visits those merchants. The degree (e.g., magnitude) of departure from normal behavior may be selected by the processing system according to experience of the degree-of-departure value that corresponds to typically unacceptable risk. This degree-of-departure value for the data, and for the user's behavior, may be measured using a variety of measures, such as mahalanabolis distance or a discriminant function analysis. The retrieved data is typically retrieved by the processing system from network data storage.

The data retrieval and decisioning may be implemented using a variety of devices. Such devices would be specially configured to perform the operations described herein. The devices may include, for example, the network devices described above, such as network computers, sensors, databases, devices that may transmit or otherwise provide data to a computing environment, including devices such as local area network devices, e.g., routers, hubs, switches, or other computer networking devices. Other network devices may also include sensors that monitor their environment or other devices to collect data regarding that environment or those devices, and such network devices may provide data they collect over time. Network devices may also include devices within the internet of things, such as devices within a home automation network. As noted above, some of these devices may be referred to as edge devices

In the next operation, at box 1112, the system computes a fraud score for the accounts, based on fraud risk. The fraud score is a score based on a data model such as a neural network. The fraud score computed at the box 1112 is based on the retrieved data and calculated data variables from the operation at box 1108.

In the next operation, at the decision box 1116, the system determines if the fraud score is above a predetermined threshold value. The threshold value is determined, for example, by system administrators during configuration of the system after considering the number of alerts per day the entity works on typically. That is, the threshold value will be different for different system implementations, depending on the number of alerts typically experienced by the entity, or other entity, for which the system is implemented. Those skilled in the art will be able to determine an appropriate value for the threshold in view of their system experience and any experimental efforts. If the fraud score is above the threshold value, an affirmative outcome at the decision box 1116, then the system processing proceeds to box 1120, where the system computes a self-similarity score for the received transaction, based on the account holder behavior.

The self-similarity score comprises a metric that is a measure of the similarity of the transaction being presented for authorization to the other transactions in the owner's purchase behavior history. That is, the self-similarity score is a score that is relevant to the card, account, or customer's past transaction behavior, relating to the purchase transaction for which authorization is requested (see box 1104), and the self-similarity score may not be a system-wide or card population metric. The self-similarity score may be, for example, a rank ordering of numbers that indicates how similar a transaction is to the previous history of the user. Thus, the self-similarity score relates to the behavior of the account owner, not of other persons who may have different spending patterns and different transaction history. The behavior history of the account owner will also be referred to as the “user's behavior history”, for convenience. The set of other, prior transactions in the account owner's purchase behavior history may be included in the data retrieved in the operation of box 1104, or may be retrieved in an additional, subsequent operation. Basing the self-similarity score on all prior transactions (i.e., raw data) is more useful than retrieving a summary of the prior transactions, because the raw data includes more information than would a summary. Following computation of a self-similarity score that is below the threshold, operation proceeds to the box 1124, where the system determines a suggested action to approve or decline the transaction. That is, the computed score corresponds to a suggestion for either approving or denying authorization of the retrieved transaction. The suggested action may be provided to the transaction processing system of the account owner or retail location.

If the fraud score is not above the predetermined threshold value, a negative outcome at the decision box 1116, the system forgoes computing the self-similarity score and instead system operation proceeds directly to determining a suggested action at the box 1124. That is, a fraud score above the predetermined threshold indicates a transaction of greater than tolerable risk, but if the fraud score does not indicate too great a risk, then the self-similarity score at box 1120 is not computed. In that situation, the suggested action will not be determined in response to a risk transaction. It should be noted that the suggested action is merely a suggestion; the decision to deny or authorize the transaction may be dependent on the entity or other institution from whom authorization is being requested by the transaction processing system. Such institutions determine how to utilize the provided fraud score and self-similarity score to improve fraud detection or reduce false positive warnings.

In the data operations illustrated in FIG. 11, multiple variable types are utilized in computing the metrics of the fraud score and the self-similarity score. For example, some of the data types are based on risk (e.g., the historical risk of a given merchant in a given location), and some data types are based on individual customer behavior (e.g., how frequently has the customer shopped at the given merchant in the given location). In general, if a variable is based on customer behavior but is still risk-related (e.g., the risk associated with frequency of purchases, by all customers, at a given merchant in a given location), then that variable belongs to the risk-based variables and is subsequently not used in the self-similarity score model.

The fraud score is computed using both types of data variables. The fraud score may be typically computed after significant pre-processing such as discretizing, transformations, imputation, normalization, and the like. The fraud score is a score indicating the probability of a card or an account being in a compromised state. Such a model typically selects and uses more risk-based variables than customer-behavior variables.

The self-similarity score utilizes only the user-behavior variables, typically without any of the above-mentioned pre-processing. The user-behavior variables are used in a customer similarity model, typically an alternating decision tree type of model. A score that indicates the probability that the current transaction is similar to the normal card, account, or customer behavior is generated. It should be noted that the self-similarity score is computed with respect to a particular transaction, whereas the fraud score is computed with respect to whether the entire card/account is in a compromised state.

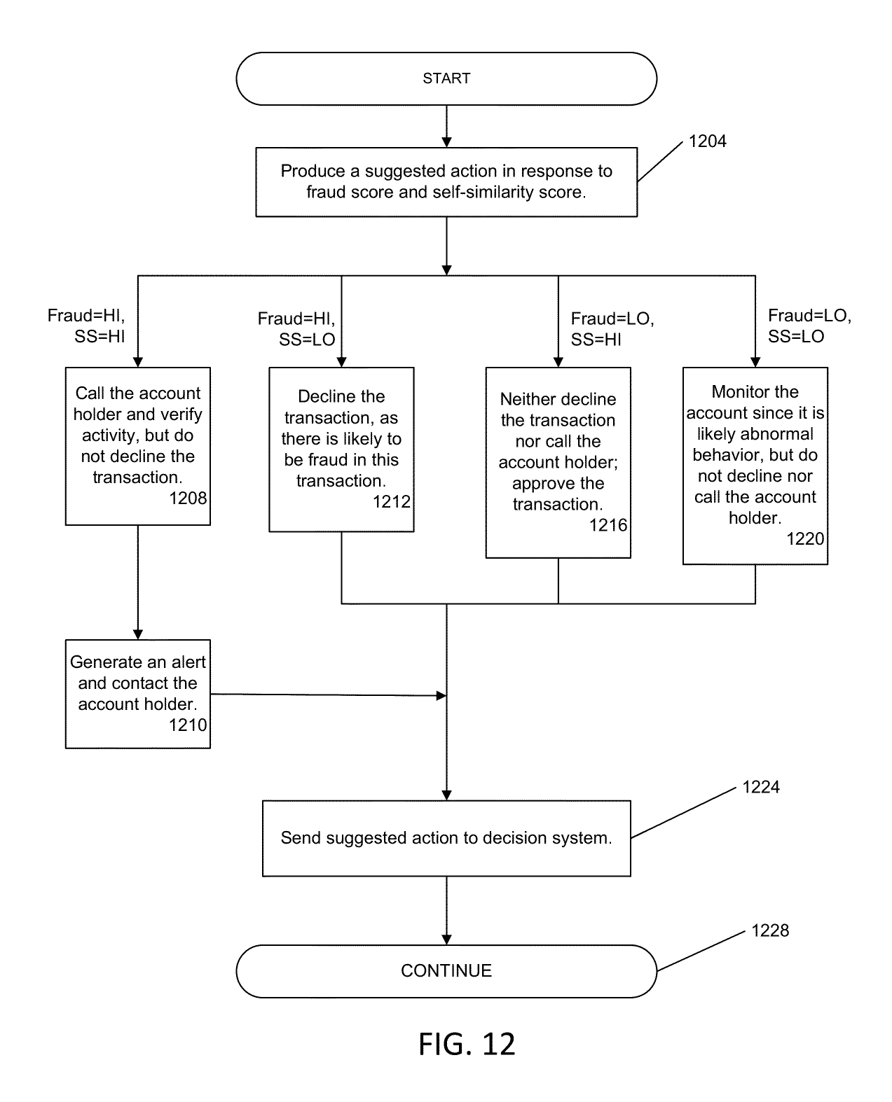

FIG. 12 illustrates another example of a flow diagram for generating transaction scores related to transactions involving a customer account. The FIG. 12 operation illustrates how the computer-implemented environment will respond to various combinations of fraud score and self-similarity score to provide a suggested response with respect to the transaction submitted for authorization, with initiation of the suggestion processing represented by the box 404. For example, the combinations of fraud score and self-similarity score may comprise a fraud score that is rated high and also a self-similarity score that is rated high, or may include a high fraud score and a low self-similarity score, or may comprise a low fraud score and a high self-similarity score, or may comprise a low fraud score and a low self-similarity score. In this context, “high” and “low” scores are relative terms and could vary from entity to entity. That is, precise definitions or numerical values of “high” and “low” scores may vary among institutions such as entities, because they have different operating ranges in terms of numbers of alerts they can each create and process per day. Therefore, an entity can define what is meant by these “high” and “low” scores depending on their operating capacity.

The first produced suggested action, in response to a high fraud score and high self-similarity score, occurs at box 1208, where the system suggests a notify to the account holder to verify the transaction activity, but the system does not suggest declining to authorize the transaction in this situation, because the high self-similarity score indicates that the transaction might, in fact, be initiated by the actual account owner. In conjunction with suggesting to contact the account owner but not decline the transaction, the system responds to a high fraud score and high self-similarity score by action to the transaction processing system for generating an alert and sending a message to contact the account holder at box 1210. Processing then continues by the system sending the suggested action to the transaction decision system at the box 1224. Operation of the system then continues according to system processing at the box 1228.

The next situation, at box 1212, occurs when the fraud outcome is high and the self-similarity score is low. At the box 1212, the processing system suggests to decline the transaction, as there is likely to be fraud involved in the transaction submitted for review, because the transaction does not support a sufficient similarity to the account owner's history of transaction behavior. Processing then continues by the system sending the suggested action to the transaction decision system at box 1224, followed by continued operation at the box 1228.

In the third pair of score outcomes, a low fraud score and a high self-similarity score, at box 1216 the system suggests to neither decline the transaction nor call the account owner. In this situation, the system suggests to approve the transaction because the fraud risk is low and the submitted transaction is consistent with the account owner's prior behavior. Processing then continues with sending the suggested action to the decision system of the processor, at box 1224, followed by continued operation of the system at the box 1228.

In the fourth pair of outcomes, a low fraud score and a low self-similarity score, at the box 1220 the system suggests monitoring the account, without declining the authorization and without contacting the account owner, because the low fraud score and high self-similarity score indicate it is likely abnormal behavior, but there is not a great risk of a fraudulent transaction. Processing then continues with sending the suggested action to the decision system of the transaction processor, at the box 1224, followed by continuation of operation at the box 1228.

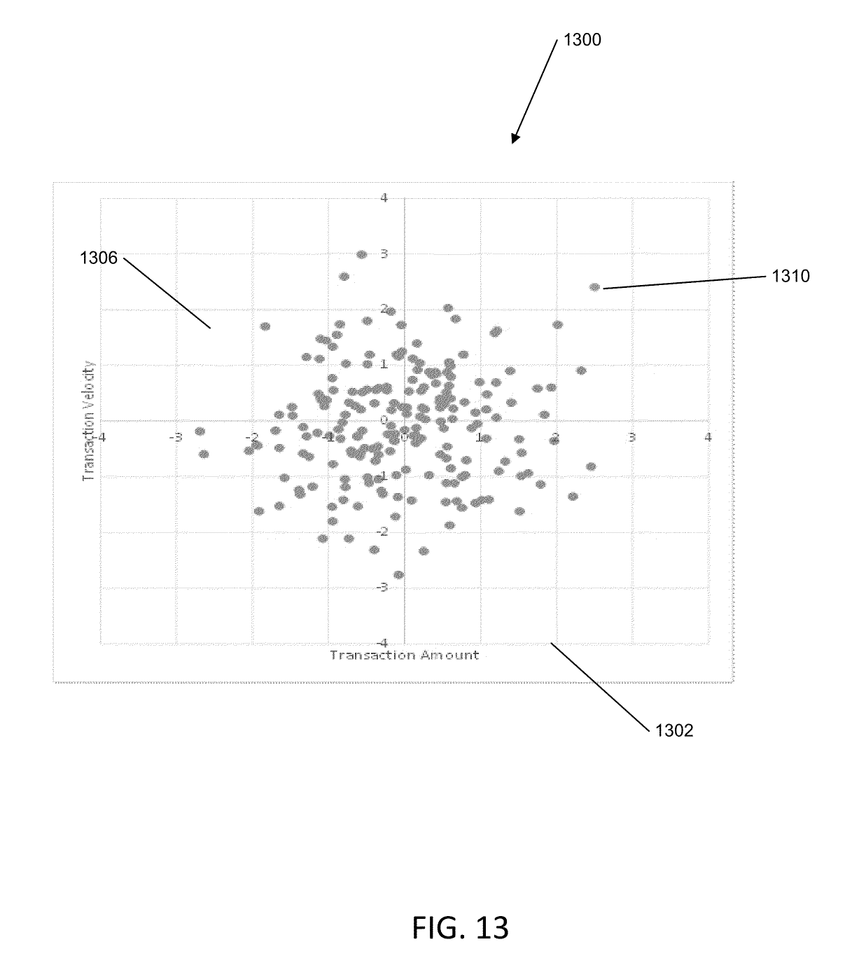

FIG. 13 illustrates a graphical user interface display 1300 that depicts transaction data of an individual with transaction amount along the horizontal x-axis 1302 and transaction velocity along the vertical y-axis 1306. “Velocity” in FIG. 13 is a measure of the frequency of the account transactions. More particularly, the numerical data for transaction amounts and for transaction velocity are z-scaled and thus centered at (0, 0) for each quantity. That is, numerical data of “0” (zero) represents the average for that quantity (i.e., amounts, or velocity) for a given account/customer. After z-scaling on the customer/account level, both the transaction amount and transaction velocity are centered to (0,0), which are the mean/average values for each respective quantity for that customer/account. A higher (in the positive direction) transaction amount represents a transaction of a higher amount than average for the particular user account. A lower transaction amount represents a transaction of a lower amount than average. Similarly, a higher (positive) transaction velocity represents a higher transaction velocity for that user account. A lower transaction velocity represents a transaction velocity of a lower amount than average. It has been determined in this example that the number of account transactions typically needed to determine a reliable self-similarity score can be collected in approximately one month of transactions by a typical customer or in a typical user account. Other time frames can be used in other example.

The chart of FIG. 13 is useful for illustration, for visualization of the data operations, but the chart is not a requirement for operations, nor is it essential in the decision-making process for authorization or computation of the self-similarity score. In the chart in the display 1300 of FIG. 13 for Transaction Velocity versus Transaction Amount, the dots of the chart represent data points that show a customer's normal transaction history, with a concentration of dots (data points) toward the center of the display 1300, where transaction amount and transaction velocity are somewhat related. The outlying dot 1310, in the upper right section of the display, represents the point where an example (newest transaction) is currently being processed. Being an outlying dot, away from the cluster at the origin (0,0), the new dot 1310 is somewhat farther away from the customer's normal behavior, represented by the center of the display 1300. Such a relationship could be one of many indicators that this particular purchase transaction is unusual for the account owner customer. If this particular purchase were also a medium to high fraud risk, then it could be logical to decline the transaction, because it would represent a high fraud risk. Even if it was a false positive (i.e., not really a fraud situation), the status of the transaction as a data outlier could make it easier to explain to the account owner customer why the response to the transaction authorization was to decline.

If the outlier dot 1310 were located in the middle of the clustered dots, closer to the chart origin (0,0) point, then the transaction represented by the dot 1310 would be very similar to other transactions previously made by the customer. If this transaction was a medium or high fraud risk, this new measure (i.e., from a method described herein) may reduce the likelihood of a “decline” suggestion. This is because it may be unwise to decline the transaction indicated with a dot 1310, because if it was a false positive (i.e., not really fraud), at least because the customer may become frustrated with their experience and decide to purchase elsewhere.

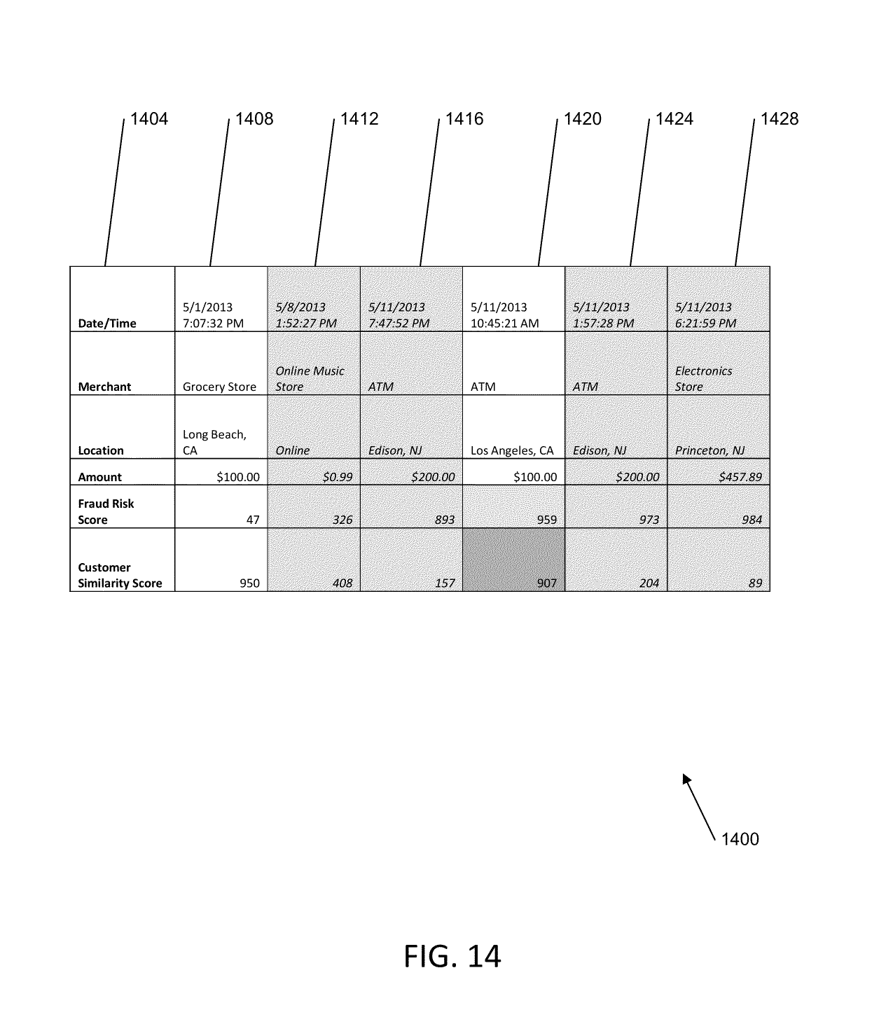

In the table 1400 of FIG. 14, transactions and attempted authorizations are detailed, indicated by rows in the left column 1404 having row headings of Date/Time, Merchant, Location, Amount, Fraud Risk Score, and Customer Similarity Score. The table 1400 represents multiple transactions with corresponding indications of reliability and of attempted fraud, as will now be described further.

The table 1400 shows a customer who resides in Long Beach, Calif., USA and who engaged in a legitimate transaction, represented by the first data column 1408. The table 1400 also indicates that authorization attempts were made by a fraudster, indicated by the columns 1412, 1415, 1424, and 1428 (text in italics). The ATM transaction 1420 at 10:45 AM is a legitimate transaction, as may be seen from the relatively high self-similarity score and the geographic proximity to the account owner's location.

Without the customer self-similarity score (i.e., from the technique described herein) that is indicated in the bottom row of the table 1400, all transactions beginning with the 10:45 AM ATM transaction would probably be declined, even though the 10:45 AM transaction is a legitimate customer transaction. The customer likely would be irritated to find the ATM transaction declined, because the ATM transaction is in the relatively local area, at an ATM that is commonly used by the customer.

With the advent of the customer similarity score, as indicated in the bottom row of the data table 1400, although the fraud risk score indicates that the card is most likely currently compromised, the customer similarity score indicates that this particular transaction 1420 is a “normal” behavior for the account owner, and is not a data outlier. This additional score, the self-similarity score, gives the institution additional information that can be used in deciding whether or not to decline the ATM withdrawal transaction at 10:45 AM, even though there is currently a high fraud risk for the card.

The table below (Table 1) lists examples of some of the scenarios and corresponding benefits that this new score will provide to the entity strategy, which are also described in connection with FIG. 13 above.

TABLE 1

| Customer | Fraud | |
|---|---|---|
| Similarity | Risk | |
| Score | Score | Strategy Benefit |
| HI | HI | False positive reduction. |
| HI | LO | Increases confidence that transaction is legitimate. |
| LO | HI | Increases confidence that transaction is fraud. |
| LO | LO | Likely change in customer spending behavior or a |
| | | fraudulent transaction not catchable by the current |
| | | fraud risk score. An increase in volume of these |
| | | greater than usual may indicate the fraud risk score |
| | | is no longer as effective as previous scores. |

In some embodiments, this method can help to address the problem when a customer finds out that their card is compromised, the entity issues a replacement card, and the customer cannot use any cards (or maybe even their account) until they receive their new card. With this disclosed method, the customer can still use the compromised card to keep transacting legitimate transactions until the new card arrives and is activated.

When account users, or account owners, use their credit or debit cards while travelling, the resulting transactions may be incorrectly flagged as fraudulent, or the cards may be incorrectly viewed as in a compromised state. This situation transpires because transactions that occur during travel are often considered as away-from-home transactions that are of increased risk and likely to be fraudulent. For example, legitimate transactions from customers who happen to be traveling can be flagged as fraudulent, or the cards may be alerted as being in a compromised condition by entity anti-fraud systems. A potentially big problem with this approach is that the burden is placed on the customer to correct the situation. Entities get complaints from customers that the entity should have known about their upcoming travel, as they used the same card to make the travel purchases. The entities' typical solution is to request customers to notify entities prior to their travel so that the entities can suppress the scores from fraud models during the customer's travel period. Specifically, card issuers usually expect customers to call in advance before traveling and to notify them about their future travel plans to avoid transactions being declined. This is an inconvenience to customers and often results in customer dissatisfaction. Also, a manual approach such as this would suppress the score of any potential real fraud episodes during the time of travel. The customer's point of view is that the issuer should know that they are about to travel as they made travel purchases, e.g., purchased airline tickets, or booked hotels using the issuer cards.

Various embodiments of the current disclosure provide the issuer another type of score with which to make transaction processing decisions: the real-time travel score. Devices for computing the real-time travel score will typically be specially configured to perform the operations described herein. For example, the devices may comprise network devices that are configured to communicate with databases and computer networks maintained by issuing entities and that are configured to utilize appropriate communication protocols of the entity. The real-time travel score is computed in response to a customer transaction and can be used to determine how likely it is that the customer would be travelling. The travel score is computed using data received over a network configured to communicate with the computer system, such as the data transmission network of FIG. 1. For away-from-home, card-present transactions, the issuer could use this travel score in conjunction with a fraud score to improve the real-time anti-fraud decisions. Along with the fraud score, the availability of the travel score gives the issuer another option to choose different score thresholds for transaction decisioning, depending on the number of customers they want to affect and the number of fraud detections, e.g., for reducing false positives or improving detection. The travel score can be used either in conjunction with the fraud score or by itself, when the issuer wishes to take some actions based on a computation of how likely it is that the customer will be traveling.

This disclosed solution, by producing a separate travel score, enables the issuer to provide a better customer experience and improve fraud detection. The travel score is produced using hundreds of complex variables derived based on the transactional history using machine learning techniques, such as neural networks and statistical analysis. A few examples include the average amount spent on airline purchases during particular time of the year from certain geographical locations, and the number of travel related purchases, such as airline, hotel, car rental, rail, bus/charter, cruise, and tour operators, among others.

The disclosed travel score solution provides a multi-entity, signature-based, real-time travel score for a transaction. Various embodiments of this disclosure make use of multi-entity level, past signature information to produce a travel score that indicates how likely it is that a customer will be traveling at the time of a transaction. The multiple entities could include a credit card, debit card, an account, a customer, or terminals, for example.

Even though it is not uncommon for customers to have multiple cards from multiple issuers, and customers have various choices for certain cards to use for making a transaction, there is still substantial benefit that can be extracted from use of the travel score. For example, customers often tend to use one specific card for travel related purchases, use another card for grocery purchases, use a third card for gasoline due to incentives offered by different card issuers, and so forth. Also, if the customer chooses a card from one issuer to make a travel purchase and uses a card from a different issuer while in travel, from the entity's perspective, a valid claim can be made that the entity did not possess complete information about the customer to make a better anti-fraud decision.

The travel score is a calculation based on a customer's signature information, or profile data. The travel score is based on a customer's past usage patterns and transaction history. Included in a customer's signature information is information about the customer's charge history relating to travel, such as making reservations for transportation or lodging, or making purchases for goods and services, involving locations that are geographically remote from the customer's usual home location, or locations, in the case of customer's with multiple residences. In this way, the disclosed travel score for a transaction is a prediction of likelihood of travel, a rank ordering over a population of customers such that a higher travel score for a customer indicates an increased likelihood of that customer traveling at the time of the transaction. That is, the travel score is typically an ordinal ranking that expresses the likelihood of a customer to be travelling at the time a transaction is submitted for approval. The travel score calculation techniques may vary among system implementations and issuing entities. Such techniques may be dependent on design preferences, entity protocols and data design, system resources, and the like, and may be typically kept confidential by the respective entities.

Thus, the travel score comprises an additional tool for use in making decisions regarding transaction risk and decision making by a institution with respect to a transaction. The travel score may be used by itself, such as for making marketing decisions in response to determining that the customer is likely traveling away from home. The travel score may be used with the fraud score, to modulate decision making and processing in response to the fraud score, due to the outcome that fraud scores are generally higher when a customer is traveling as compared to when the customer is making transactions at a usual home location or geographic area.

When the travel score is used with the fraud score, the decisioning process with respect to transaction authorization may be summarized by the strategy in Table 2 below:

TABLE 2

| | Fraud | |
|---|---|---|
| Travel | Risk | |
| score | Score | Strategy Benefit |
| HI | HI | False positive reduction. |
| HI | LO | Increases confidence that transaction is legitimate. |
| LO | HI | Increases confidence that transaction is fraud. |
| LO | LO | This predominantly represents non-traveling population. |
| | | An increase in volume of these than usual indicates either |
| | | shift in the customer travel behaviors or decrease in fraud |
| | | score efficacy. |

As noted above, devices for computing the real-time travel score will typically be specially configured to perform the operations described herein, and may comprise, for example, network devices. Techniques used by such devices to calculate scores and perform decisioning may include typical machine learning methods, such as neural networks, logistic regression, and the like. Such techniques will usually be dependent on design preferences, entity protocols and data design, system resources, and the like

Thus, in accordance with Table 2 above, a travel score that is in a relatively high range of score values over a customer population can be used to provide a reduction to false positive outcomes that might otherwise result from a relatively high fraud score, and in that way the travel score can modulate a false positive of a risky transaction. A transaction with a travel score that is in a relatively high range of travel score values over a customer population can be used to increase the confidence of a relatively low fraud score that the associated transaction is likely legitimate. A travel score that is in a relatively low range of score values over a customer population can be used to increase the confidence of a relatively high fraud score that the associated transaction is likely fraudulent. A travel score that is in a relatively low range of travel score values over a customer population, along with a fraud score that is in a relatively low range of fraud score values is typically representative of a non-traveling customer population. An unusually large increase in the number of such transactions for a customer indicates either a shift in the customer's travel behaviors or a decrease in fraud score efficacy.

The disclosed travel score for a transaction is sufficient if the travel score merely gives a prediction as to whether the transaction customer is likely to be traveling at the time of the transaction. That is, it is not necessary that the travel score be a good predictor of the location to which the customer is traveling. This simplifies the data fidelity and processing operations for producing the travel score disclosed herein. For example, transaction authorization data for a travel-related transaction does not typically include destination information. Thus, a institution that provides the data from which the travel score will be computed does not typically have access to data that is sufficient to determine likely destination. In addition, institutions may be limited from obtaining such detailed information, for example, due to opt-in requirements for data sharing that have been instituted for the sake of protecting customer privacy.

It is known that the risk of fraud in a transaction is greatly increased, as much as tens or hundreds of times greater, when a customer transaction is from a location remote from the customer's home location as compared to when the customer transaction is from the customer's usual local area of transactions. In this way, the accuracy of the fraud score can be increased, or at least compensated for, if it is known that the transaction customer is traveling. Notwithstanding the advantages of simplification in data processing, in embodiments, it is possible for the travel score to be computed to produce not just a travel score, but also an indication of a “neighborhood” or region of travel for the customer relative to the customer's usual geographic area of transactions (e.g., usual transaction neighborhood or city).

When the travel score is computed, as described above, the transaction that initiated the travel score processing (as well as initiating the fraud score processing) will be part of that customer's updated signature or profile data. That is, the predictive travel score may be stored into the database associated with the customer's signature or profile data. In this way, the transaction processing system and/or institutional data base will have collected transaction data that will enable customer information to be gleaned from the data base such that it can be determined, for example, if the customer typically purchases transportation or reserves lodging well in advance of travel, or if the customer typically waits for the eve of travel before conducting such transactions. Timing information of this nature can be useful in improving the accuracy of the travel prediction (score). The transaction data useful for such purposes may include, for example, vendor data, authorization date, charge location, transaction amount, transaction type, and so forth. Decisioning with respect to the travel score and fraud score is explained further below. It should be noted, however, that exact thresholds and corresponding courses of action will vary among system implementations and card issuers. Details of such decisioning techniques will usually be dependent on design preferences, entity protocols and data design, system resources, and the like, and may be typically kept confidential by the entities performing and utilizing the scores and performing the decisioning actions.

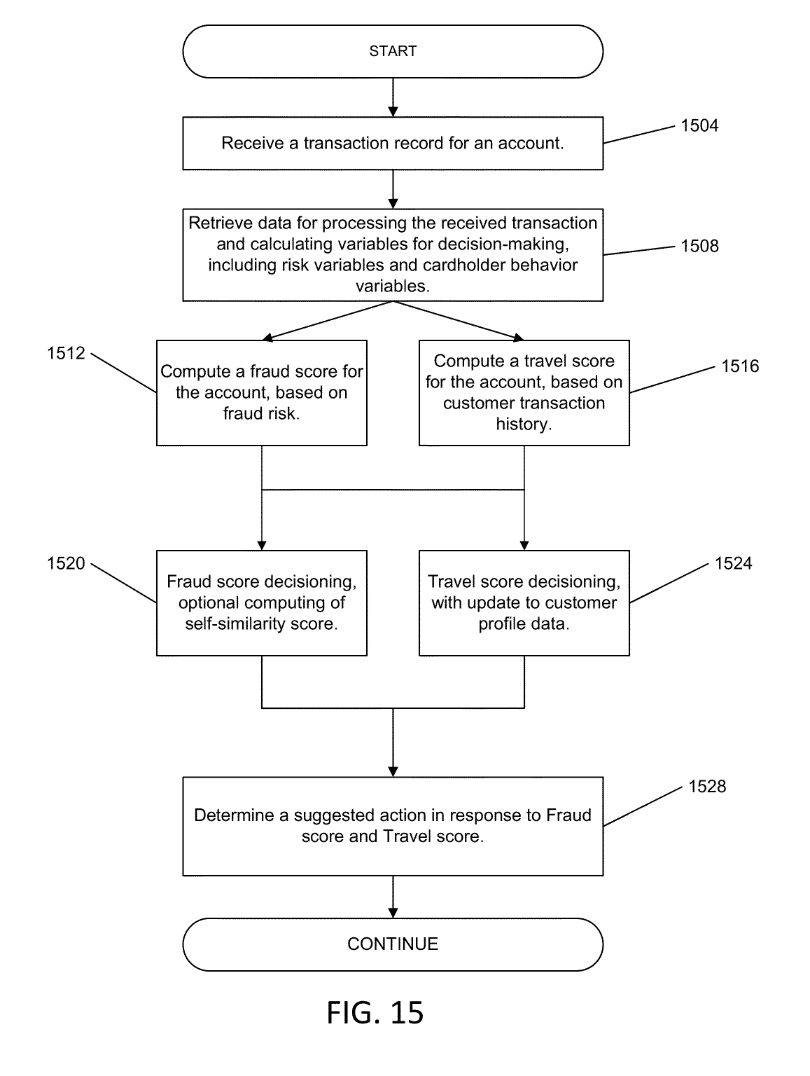

FIG. 15 illustrates an example of a flow diagram for generating transaction fraud scores and travel scores related to transactions involving a customer account. As noted above, the travel score may be used with or without the fraud score. The score computation process is initiated by a transaction.

In the first operation of FIG. 15, illustrated by the box numbered 1504, the computer-implemented environment 100 (FIG. 1) receives a transaction record for an account. The transaction record may comprise, for example, data relating to a purchase transaction for which authorization to charge an account of a customer is requested. The account typically relates to a credit or debit card, or electronic equivalent, for which the customer is obligated to make payment. A customer may have multiple accounts, but each transaction will relate to only one single account, and the customer behavior data discussed below relates to only the account associated with the transaction.

At the next operation, at the box 1508 of FIG. 15, the system retrieves data for processing the received transaction and calculates variables for decision-making and travel prediction, including risk variables and cardholder behavior variables. The retrieved data typically includes customer identification data and purchase location data, based on the card account number and the merchant information that typically accompanies the request for authorization of the transaction. The retrieved data also includes risk variables such as risk values associated with the transaction location, transaction amount, time of day, goods or services, and the like. The retrieved data is selected according to decisions of the processing system administrators during configuration of the system. The selection of data to be retrieved includes decisions by the system administrators as to the risk variables that have been deemed important to authorization decision making. That is, the data to be retrieved by the system will be selected by authorized persons during system configuration, in accordance with the user needs for the environment in which the system is being implemented, because the data will be the set of data deemed useful by system administrators in authorization decision making, which data sets may be different for different systems, users, and environments.

The retrieved data for processing a transaction also possibly includes data relating to cardholder (i.e., account owner) behavior variables. Such behavior data will typically be in the form of statistical variables, such as usual cardholder transaction locations, average cardholder transaction amount, typical transaction time of day, average amount of goods or services charged by the cardholder, and the like. For example, the “typical transaction location” risk variables may comprise an indicator that compares typical postal codes or addresses or geographic information and determines if the present transaction location corresponds to a postal code or address or other geographic information that indicates a location that is unusually risky from the locations that the cardholder normally frequents. In such an example, an “unusually risky” location is a location at which a determined location risk value (for loss or fraud) is greater than a threshold risk value set by the system implementation. The location-based risk variables as part of a risk determination for a user may include many such “typical transaction locations”, such as locations near the user's residence, near a school, near a work location, and the like. Some other examples could comprise comparison of typical merchants, merchant category code, transaction amount bins, or times of day the user visits those merchants. The degree (e.g., magnitude) of departure from normal behavior may be selected by the processing system according to experience of the degree-of-departure value that corresponds to typically unacceptable risk. This degree-of-departure value for the data, and for the user's behavior, may be measured mathematically using a variety of measures, such as mahalanabolis distance or a discriminant function analysis. The retrieved data is typically retrieved by the processing system from network data storage.

In the next operation, at box 1512, the system computes a fraud score for the accounts, based on fraud risk. The fraud score is a score based on a data model such as a neural network. Those skilled in the art will appreciate and understand the data models that are typically employed for calculating a fraud score. The fraud score computed at the box 1512 is based on the retrieved data and calculated data variables from the operation at box 1508.

In a parallel operation to fraud computation, at box 1516, the system computes a travel score for the accounts, based on the signature information and data described above. The travel score is a score that may be based on a data model such as a neural network. Those skilled in the art will appreciate and understand the data models that are suited for calculating a travel score. The travel score computed at the box 1516 is based on the retrieved data and calculated data variables from the operation at box 1508.

At the box 1520, an operation comprising fraud decisioning is performed. The fraud decisioning may include, for example, decision making in accordance with the fraud score, and may also include the self-similarity processing described in conjunction with FIG. 11 and FIG. 12 above, which may be conditional on the fraud score. At the box 1524, an operation comprising travel decisioning is performed. The travel decisioning may include, for example, decision making in accordance with the travel score, and with or without the fraud score. The connecting lines between box 1512 and 1516 indicate that the fraud decisioning and the travel decisioning may utilize the fraud score and/or the travel score. Examples of fraud score decisioning may include determining whether to calculate the self-similarity score, and whether to adjust the fraud score outcome, such as described above in conjunction with Table 2. Examples of travel score decisioning may include concluding that a customer is away from home and is traveling, may include producing marketing materials in response to determining that the customer is traveling and may be receptive to new offers or solicitations, may include updating customer signature and profile data, and the like. Devices for computing scores and performing decisioning will typically be specially configured to perform the operations described herein. For example, the devices may comprise network devices that are configured to communicate with databases and computer networks maintained by issuing entities and that are configured to utilize appropriate communication protocols of the entity. Such network devices may include, for example, the network devices described above, such as network computers, sensors, databases, devices that may transmit or otherwise provide data to a computing environment, including devices such as local area network devices, e.g., routers, hubs, switches, or other computer networking devices. Other network devices may also include sensors that monitor their environment or other devices to collect data regarding that environment or those devices, and such network devices may provide data they collect over time. Network devices may also include devices within the internet of things, such as wearable devices or network devices installed in a vehicle. As noted above, some of these devices may be referred to as edge devices.

Following the fraud score decisioning and the travel score decisioning, processing proceeds to determining a suggested action at the box 1528. That is, a suggested action is determined in response to the fraud score and the travel score. The suggested action may comprise, for example, a recommendation that a transaction should not be authorized, or it may comprise a recommendation that a transaction should be approved, or the suggested action may comprise initiating communications with the customer in response to a travel determination as to location and time of future travel. It should be noted that the suggested action is merely a suggestion; the decision to deny or authorize the transaction or initiate a customer communication may be dependent on the entity or other institution from whom authorization is being requested by the transaction processing system. Such institutions determine how to utilize the provided fraud score and self-similarity score to improve fraud detection or reduce false positive warnings.

In the data operations illustrated in FIG. 15, multiple variable types are utilized in computing the metrics of the fraud score, the self-similarity score, and the travel score. For example, some of the data types are based on risk (e.g., the historical risk of a given merchant in a given location), and some data types are based on individual customer behavior (e.g., how frequently has the customer shopped at the given merchant in the given location). In general, if a variable is based on customer behavior but is still risk-related (e.g., the risk associated with frequency of purchases, by all customers, at a given merchant in a given location), then that variable belongs to the risk-based variables and is subsequently not used in the self-similarity score model.

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be utilized. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer system comprising:
a network device having a processor; and
a non-transitory computer-readable storage medium that includes instructions that are configured to be executed by the processor such that, when executed, the instructions cause the computer system to perform operations including:
retrieving data from data storage of a system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a travel score in connection with the account to which the received transaction relates, wherein the computed travel score indicates a likelihood that a user of the account is traveling from a user home location at the time of the received transaction and is computed using data received over a network configured to communicate with the computer system;
performing one or both of a fraud decisioning operation and a travel decisioning operation in response to both the computed fraud score and computed travel score; and
determining a suggested action based on the fraud decisioning operation and the travel decisioning operation.

2. The computer system of claim 1, wherein performing the fraud decisioning operation comprises computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions.

3. The computer system of claim 1, wherein performing the travel decisioning operation comprises updating user profile data of the account user determined to be traveling.

4. The computer system of claim 1, wherein the travel decisioning operation is performed without performing the fraud decisioning operation.

5. The computer system of claim 1, wherein the determined suggested action comprises initiating a marketing process in response to a computed travel score that is above a predetermined travel threshold.

6. The computer system of claim 1, wherein the determined suggested action comprises reducing a fraud risk ranking for the received transaction, in response to a computed fraud score that is above a predetermined fraud threshold and a computed travel score that is above a predetermined travel threshold.

7. The computer system of claim 1, wherein the determined suggested action comprises reducing a fraud risk ranking for the received transaction in response to a computed fraud score that is below a predetermined fraud threshold and a computed travel score that is above a predetermined travel score threshold.

8. The computer system of claim 1, wherein the determined suggested action comprises increasing a fraud risk ranking for the received transaction in response to a computed fraud score that is above a predetermined fraud threshold and a computed travel score that is below a predetermined travel score threshold.

9. The computer system of claim 1, wherein the determined suggested action comprises updating user profile data of the account user in response to a computed fraud score that is below a predetermined fraud threshold and a computed travel score that is below a predetermined travel score threshold.

10. The computer system of claim 1, wherein the performed operations further comprise providing the suggested action to a transaction processing system.

11. A computer-program product tangibly embodied in a non-transitory machine-readable storage medium for a data processing apparatus of a computer system, the computer-program product including instructions configured to be executed to cause the data processing apparatus comprising a network device having a processor to perform a method comprising:
retrieving data from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a travel score in connection with the account to which the received transaction relates, wherein the computed travel score indicates a likelihood that a user of the account is traveling from a user home location at the time of the received transaction and is computed using data received over a network configured to communicate with the computer system;
performing one or both of a fraud decisioning operation and a travel decisioning operation in response to the computed fraud score and computed travel score; and
determining a suggested action based on the fraud decisioning operation and the travel decisioning operation.

12. The computer-program product of claim 11, wherein performing the fraud decisioning operation comprises computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions.

13. The computer-program product of claim 11, wherein performing the travel decisioning operation comprises updating user profile data of the account user determined to be traveling.

14. The risk assessment computer system of claim 11, wherein the travel decisioning operation is performed without performing the fraud decisioning operation.

15. The computer-program product of claim 11, wherein the determined suggested action comprises initiating a marketing process in response to a computed travel score that is above a predetermined travel threshold.

16. The computer-program product of claim 11, wherein the determined suggested action comprises reducing a fraud risk ranking for the received transaction, in response to a computed fraud score that is above a predetermined fraud threshold and a computed travel score that is above a predetermined travel threshold.

17. The computer-program product of claim 11, wherein the determined suggested action comprises reducing a fraud risk ranking for the received transaction in response to a computed fraud score that is below a predetermined fraud threshold and a computed travel score that is above a predetermined travel score threshold.

18. The computer-program product of claim 11, wherein the determined suggested action comprises increasing a fraud risk ranking for the received transaction in response to a computed fraud score that is above a predetermined fraud threshold and a computed travel score that is below a predetermined travel score threshold.

19. The computer-program product of claim 11, wherein the determined suggested action comprises updating user profile data of the account user in response to a computed fraud score that is below a predetermined fraud threshold and a computed travel score that is below a predetermined travel score threshold.

20. The computer-program product of claim 11, wherein the performed operations further comprise providing the suggested action to a transaction processing system.

21. The computer-program product of claim 11, further comprising instructions for providing the suggested action to a transaction processing system.

22. A method of operating a computer system, the method comprising:
retrieving data, at a network device of the computer system, from data storage of the system in connection with a transaction received at the system relating to an account, wherein the data storage includes data relating to a plurality of accounts, each of which is associated with an account owner, and wherein the collection of accounts comprises an account population;
computing a fraud score in connection with the account to which the received transaction relates, wherein the computed fraud score indicates a probability of the account being in a compromised condition;
computing a travel score in connection with the account to which the received transaction relates, wherein the computed travel score indicates a likelihood that a user of the account is traveling from a user home location at the time of the received transaction and is computed using data received over a network configured to communicate with the computer system;
performing one or both of a fraud decisioning operation and a travel decisioning operation in response to the computed fraud score and computed travel score; and
determining a suggested action based on the fraud decisioning operation and the travel decisioning operation.

23. The method of claim 22, wherein performing the fraud decisioning operation comprises computing a self-similarity score in response to a computed fraud score that is above a predetermined threshold, the self-similarity score comprising a similarity measure of the received transaction relative to a set of prior transactions in the data storage relating to the account, wherein the computed self-similarity score indicates similarity of the received transaction to other transactions of the account in the set of prior transactions.

24. The method of claim 22, wherein performing the travel decisioning operation comprises updating user profile data of the account user determined to be traveling.

25. The method of claim 22, wherein the travel decisioning operation is performed without performing the fraud decisioning operation.

26. The method of claim 22, wherein the determined suggested action comprises initiating a marketing process in response to a computed travel score that is above a predetermined travel threshold.

27. The method of claim 22, wherein the determined suggested action comprises reducing a fraud risk ranking for the received transaction, in response to a computed fraud score that is above a predetermined fraud threshold and a computed travel score that is above a predetermined travel threshold.

28. The method of claim 22, wherein the determined suggested action comprises reducing a fraud risk ranking for the received transaction in response to a computed fraud score that is below a predetermined fraud threshold and a computed travel score that is above a predetermined travel score threshold.

29. The method of claim 22, wherein the determined suggested action comprises increasing a fraud risk ranking for the received transaction in response to a computed fraud score that is above a predetermined fraud threshold and a computed travel score that is below a predetermined travel score threshold.

30. The method of claim 22, wherein the determined suggested action comprises updating user profile data of the account user in response to a computed fraud score that is below a predetermined fraud threshold and a computed travel score that is below a predetermined travel score threshold.
